(19) United States
(12) Patent Application Publication
(10) Pub. No.: US 2021/0357301 A1
(43) Pub. Date: Nov. 18, 2021

(54) MONITORING SYSTEM, MONITORING APPARATUS, AND MONITORING METHOD

(71) Applicant: Hitachi, Ltd., Tokyo (JP)

(72) Inventors: Ayame KOGA, Tokyo (JP); Kazuki OOTSUBO, Tokyo (JP); Yasuaki SAITO, Tokyo (JP)

(73) Assignee: Hitachi, Ltd.

(21) Appl. No.: 17/207,264

(22) Filed: Mar. 19, 2021

(30) Foreign Application Priority Data
May 14, 2020 (JP) 2020-085162

(51) Int. Cl. G06F 11/30; G06F 11/32; G06F 11/07

(52) U.S. Cl. CPC G06F 11/3072; G06F 11/327; G06F 2201/86; G06F 11/0787; G06F 11/0781

(57) ABSTRACT

It is made possible to grasp a situation and to more quickly provide handling when a failure occurs in a monitored system. A monitoring system 10 includes: an event management section 37 that manages a plurality of events occurring in a monitored system 20; an event analysis section 34 that analyzes the plurality of events, based on components of the monitored system 20, timings of occurrence of the plurality of events, and records of handling performed in the past, and classifies relatedly occurring events into the same group; and a notification section 32 that notifies the plurality of events on a group basis.

### BACKGROUND OF THE INVENTION

### Field of the Invention

The present invention relates to a monitoring system, a monitoring apparatus, and a monitoring method that monitor a monitored system.

### Description of the Related Art

Conventionally, there have been work assistance systems, and for example, a technique disclosed in Japanese Patent Laid-Open No. 2007-213294 is among such systems. In the document, a following statement is seen: “In production planning, the executable plan is created by adjusting a production capacity for production work sites in consideration of a period with a fixed production capacity in each work site, a period with worker-flexibility between work sites, and a period needing no consideration of the production capacity due to the employment new personnel.” As in such a case, IT systems have become larger in scale and more complicated, with automation, optimization, and smartification of a variety of work and operations, and with development of virtualization technology for infrastructure equipment supporting the automation, optimization, and smartification of work and operations.

According to Japanese Patent Laid-Open No. 2007-213294, it can be made possible that when a production plan is created, an executable production plan can be created while allocation of workers to work sites are taken into consideration. In such a system, an event notifying abnormality is generated when a failure or the like occurs in a component, such as a server or a storage, of the system.

However, in a large-scale system, many components are complicatedly related, and a problem has therefore been addressed that when a plurality of events occur, it is difficult to locate a place of a failure and to grasp a relation between the events, and hence to quickly provide handling.

Accordingly, an object of the present invention is to grasp a situation and to more quickly provide handling when a failure occurs in a monitored system.

### SUMMARY OF THE INVENTION

To achieve the above object, a typical one of monitoring systems and monitoring apparatuses according to the present invention includes: an event management section that, manages a plurality of events occurring in a monitored system; an event analysis section that analyzes the plurality of events, based on components of the monitored system, timings of occurrence of the plurality of events, and records of handling performed in the past, and classifies relatedly occurring events into the same group; and a notification section that notifies the plurality of events on a basis of the group.

A typical one of monitoring methods according to the present invention includes: an event management step of managing a plurality of events occurring in a monitored system; an event analysis step of analyzing the plurality of events, based on components of the monitored system, timings of occurrence of the plurality of events, and records of handling performed in the past, and classifying relatedly occurring events into the same group; and a notification step of notifying the plurality of events on a basis of the group.

According to the present invention, it is made possible to grasp a situation and to more quickly provide handling when a failure occurs in a monitored system.

Objects, configurations, and advantageous effects other than those described above will become clear through a description of a preferred embodiment given below.

### BRIEF DESCRIPTION OF THE DRAWINGS

FIG. 1 is a configuration diagram of a monitoring system according to an embodiment;

FIG. 2 is a configuration diagram showing components of a monitored system;

FIG. 3 shows a specific example of data in the monitoring system (part 1);

FIG. 4 shows a specific example of data in the monitoring system (part 2);

FIG. 5 shows a specific example of data in the monitoring system (part 3);

FIG. 6 shows a specific example of data in the monitoring system (part 4);

FIG. 7 is a flowchart showing a procedure of processing in the monitoring system;

FIG. 8 is a flowchart showing details of processing for grouping events shown in FIG. 7;

FIG. 9 is a flowchart showing details of calculation of time-wise distances shown in FIG. 8;

FIG. 10 is a flowchart showing details of calculation of handling history-based distances shown in FIG. 8;

FIG. 11 is a flowchart showing details of calculation of final distances and grouping shown in FIG. 8;

FIG. 12 is a flowchart showing details of calculation of degrees of priority shown in FIG. 7;

FIG. 13 is a flowchart showing details of calculation of factor values shown in FIG. 12;

FIG. 14 is a flowchart showing details of determination of degrees of priority shown in FIG. 12;

FIG. 15 is a flowchart showing details of output of a display shown in FIG. 7;

FIG. 16 is an explanatory diagram about, a specific example of the display; and

FIG. 17 is a flowchart showing details of parameter adjustment shown in FIG. 7.

### DETAILED DESCRIPTION OF THE PREFERRED EMBODIMENT

Hereinafter, an embodiment of the present invention will be described with reference to drawings. Note that the embodiment described below is not intended to limit the invention according to claims, and not all of elements and combinations of the elements described in the embodiment are necessarily indispensable to solutions for the invention.

In the following description, information that is an output obtained from an input is described with an expression “xxx table” in some cases, but such information may be data in any form of structure. Accordingly, “xxx table” can be translated as “xxx information”.

In the following description, a configuration of each table is an example. A single table may be divided into two or more tables, and all or some of two or more tables may be a single table.

In the following description, processing is described by using a “program” for a subject of a sentence in some cases. However, since a program performs predetermined processing by being executed by a processor section while using a storage section and/or an interface section as appropriate, a subject, to “processing” may be a processor section (or a device, such as a controller, including the processor section).

The program may be installed into an apparatus such as a computer, or may be present in, for example, a program distribution server- or computer-readable (for example, non-transitory) recording medium. In the following description, two or more programs may be created as a single program, and a single program may be created as two or more programs.

The “processor section” is one or more processors. A processor is typically a microprocessor such as a CPU (Central Processing Unit), but may be another type of processor such as a GPU (Graphics Processing Unit). Moreover, a processor may be single-core or multi-core. A processor may be a processor in a broad sense, such as a hardware circuit (for example, FPGA (Field-Programmable Gate Array) or ASIC (Application Specific Integrated Circuit)) that performs part, or a whole of processing.

In the following description, identification numbers are used for identification information on various subjects. However, other types of identification information than Identification numbers (for example, identifiers including alphabets and signs) may be used.

In the following description, when elements of the same type are indistinctively described, a reference sign (or a common sign in reference signs) is used, and when elements of the same type are distinctively described, respective identification numbers (or reference signs) of the elements are used in some cases.

### Embodiment

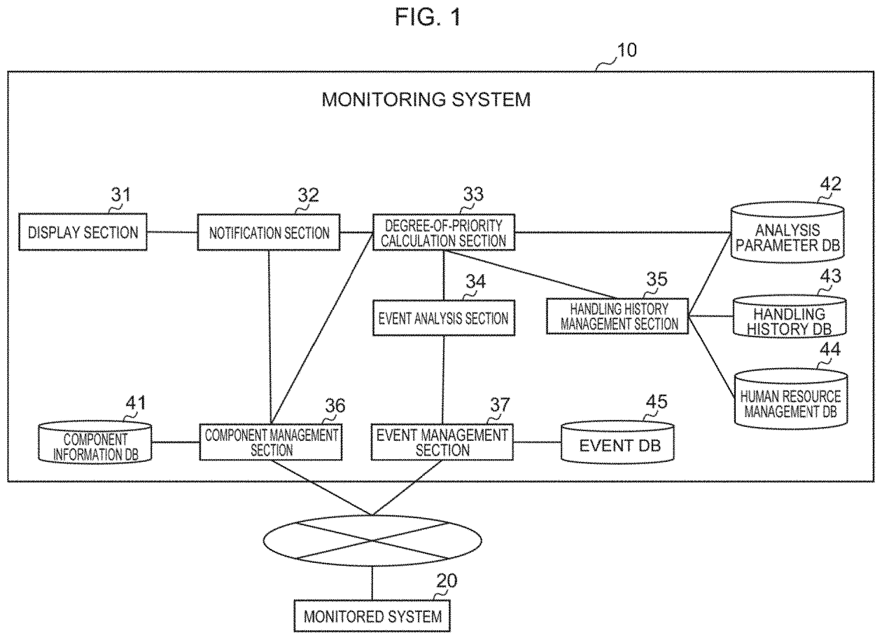

FIG. 1 is a configuration diagram of a monitoring system according to an embodiment. As shown in FIG. 1, the monitoring system 10 is coupled to a monitored system 20 through a network. The monitoring system 10 internally includes a display section 31, a notification section 32, a degree-of-priority calculation section 33, an event analysis section 34, a handling history management section 35, a component management section 36, and an event management section 37. The monitoring system 10 further includes a component information DB (database) 41, an analysis parameter DB 42, a handling history DB 43, a human resource management DB 44, and an event DB 45.

The component information DB 41 is a database that stores information related to components of the monitored system 20. The analysis parameter DB 42 is a database that stores various parameters used when an event occurring in the monitored system 20 is analyzed. The handling history DB 43 is a database that stores a history of handling of an event occurring in the monitored system 20. The human resource management DB 44 is a database that stores information related to human resources including an operator of the monitoring system 10. The event DB 45 is a database that stores an event occurring in the monitored system 20.

The display section 31 is, for example, a liquid crystal panel or the like, and is used to output a display to an operator. The notification section 32 is a processing section that controls a content of a notification to the operator by generating a display screen on the display section 31. The degree-of-priority calculation section 33 is a processing section that calculates a degree of priority of each group in a notification when events are grouped and notified on a group basis.

The event analysis section 34 is a processing section that analyzes and groups events. The handling history management section 35 registers and manages records of handling performed in the past in the handling history DB 43. The component management section 36 registers and manages the components of the monitored system 20 in the component information DB 41. The event management section 37 registers and manages a plurality of events occurring in the monitored system 20 in the event DB 45.

Specifically, the event analysis section 34 analyzes a plurality of events, based on the components of the monitored system 20, timings of occurrence of the plurality of events, and the records of handling performed in the past, and classifies relatedly occurring events into the same group. The monitored system 20 includes a plurality of service systems that provide a plurality of services, respectively, and the event analysis section 34 can classify a plurality of events occurring across different service systems into the same group.

Moreover, the event analysis section 34 adjusts a parameter involved in group classification, based on operation made by an operator who satisfies a predetermined condition, and registers the adjusted parameter in the analysis parameter DB 42, whereby the adjusted parameter is reflected in subsequent analysis.

The degree-of-priority calculation section 33 calculates a degree of priority of each group, based on a degree of significance, the number of related devices, a degree of importance of a system, and a time period required for handling of each event classified into the same group.

The notification section 32 notifies a plurality of events on a group basis. The notification section 32 notifies a degree of priority along with each group. As an example of a notification, a display screen is generated that displays the components of the monitored system 20 in a form of a tree structure, and that displays each group in such a manner that the group is associated with an uppermost node, in the tree, that includes events classified into the group.

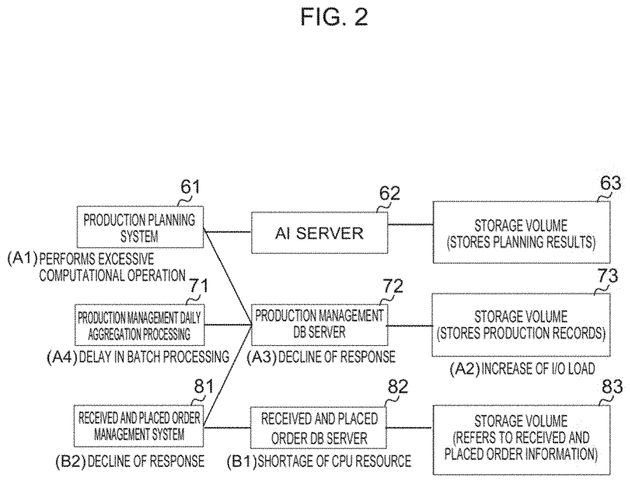

FIG. 2 is a configuration diagram showing the components of the monitored system 20. As shown in FIG. 2, the monitored system 20 includes, as service systems, a production planning system 61, production management daily aggregation processing 71, and a received and placed order management system 81.

The production planning system 61 includes an AI server 62 and a storage volume 63 as components. The production management daily aggregation processing 71 includes a production management DB server 72 and a storage volume 73 as components. The received and placed order management system 31 includes a received and placed order DB server 32 and a storage volume 83 as components.

Moreover, the production planning system 61 can access the production management DB server 72 and use data from the production management daily aggregation processing 71. Similarly, the received and placed order management system 81 can access the production management DB server 72 and use the data from the production management daily aggregation processing 71.

FIG. 2 shows specific examples of failures occurring in the monitored system 20. First, when the production planning system 61 performs excessive computational operation (A1), an I/O load on the storage volume 73, which is a component of the production management daily aggregation processing 71, increases (A2), and response of the production management DB server 72 declines (A3). As a result, a delay in batch processing occurs in the production management daily aggregation processing 71 (A4).

FIG. 2 further shows a state where a shortage of a CPU resource (B1) occurs in the received and placed order DB server 82, and a decline of response (B2) is consequently caused in the received and placed order management system 81, as failures independent of a series of the failures (A2 to A4) attributable to the excessive computational operation (A1) in the production planning system 61.

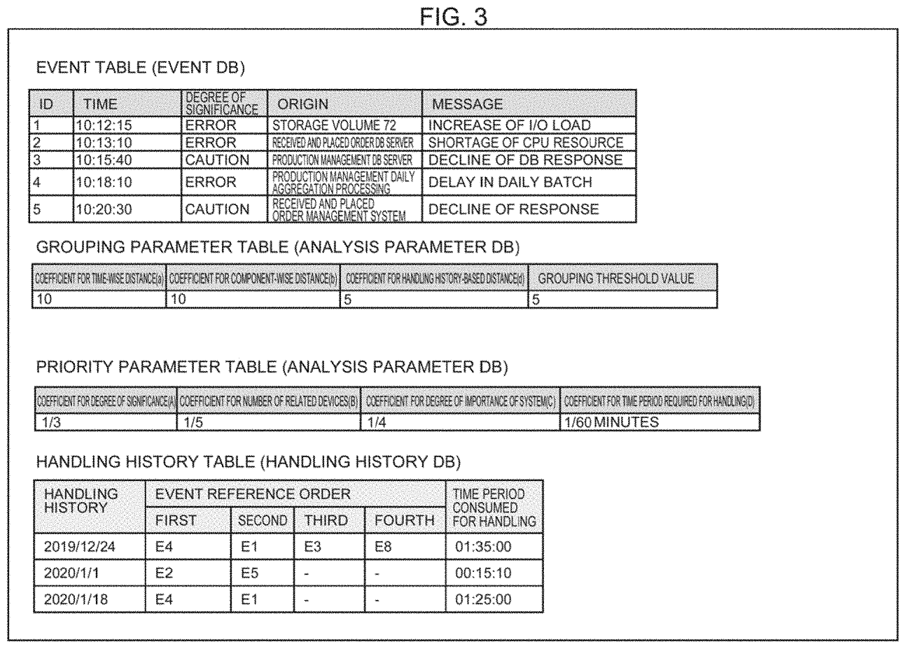

FIGS. 3 to 6 show specific examples of data in the monitoring system 10. An event table in FIG. 3 is a table stored in the event DB 45. The event table includes, as items, ID that is an identification number assigned to an event in chronological order of a time of occurrence, time that is a time of occurrence, degree of significance that indicates how serious the event is, origin that indicates in which component the event occurs message that indicates details of the event, and the like.

A grouping parameter table in FIG. 3 is a table stored in the analysis parameter DB 42. The grouping parameter table includes, as items, coefficient for a time-wise distance, coefficient for a component-wise distance, coefficient for a handling history-based distance, and grouping threshold value.

A priority parameter table in FIG. 3 is a table stored in the analysis parameter DB 42. The priority parameter table includes, as items, coefficient for a degree of significance, coefficient for the number of related devices, coefficient for a degree of importance of a system, and coefficient for a time period required for handling, with respect to a group.

A handling history table is a table stored in the handling history DB 43. The handling history table includes, as items, date and time when handling was performed, reference order followed when handling was performed, and time period consumed for handling. The reference order followed when handling was performed indicates in what order an expert who handled events referred to information on the events. The events that were referred to are denoted by identification information (E1 to E5) that can identify types of the events. The expert is, for example, a skilled operator who has a skill at a predetermined level or higher.

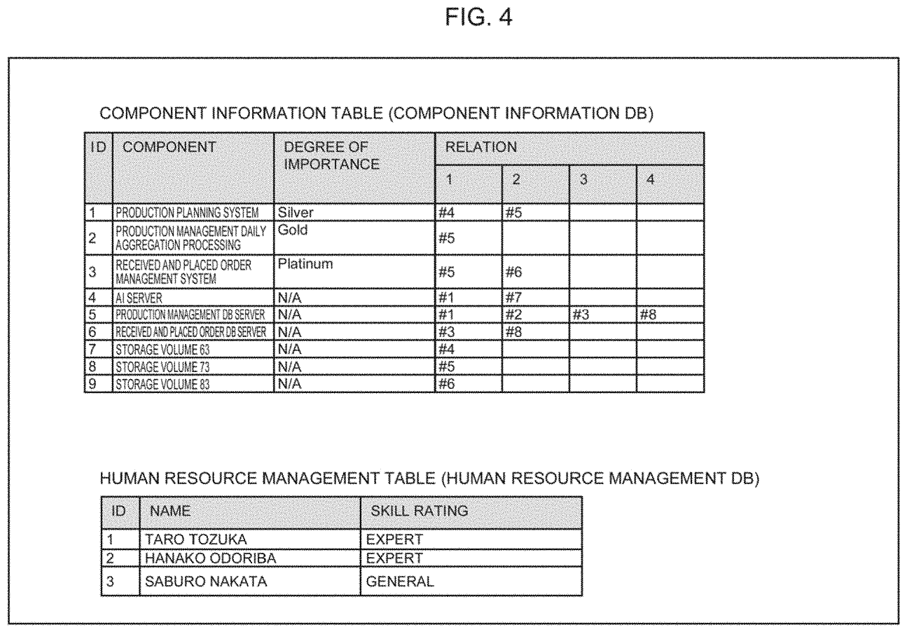

A component information table shown in FIG. 4 is a table stored in the component information DB 41. The component information table includes, as items, ID, component, degree of importance, and relation. The ID in the component information table is information for uniquely identifying a component in the monitored system 20. The item “component” is a name or the like of the component. The degree of importance indicates how important the component is in the monitored system. Under the item “relation”, other components directly coupled to the component are listed.

A human resource management table shown in FIG. 4 is a table stored in the human resource management DB 44. The human resource management table includes, as items, ID, name, and skill rating. The ID is identification information for uniquely identifying a human resource such as an operator registered in the human resource management table. The name indicates a name of the human resource such as the registered operator. The skill rating is a rating of a skill as an operator, and indicates whether the human resource applies to “general”, or applies to “expert”.

A distance table shown in FIG. 2 is a table indicating a result of evaluation of a relationship between a plurality of events. The result of evaluation is indicated as a “final distance”. For example, an event “ID1” has a distance of “5.39” from an event “ID2”, a distance of “0.64” from an event “ID3”, a distance of “0.99” from an event “ID4”, and a distance of “6.03” from an event “ID5”.

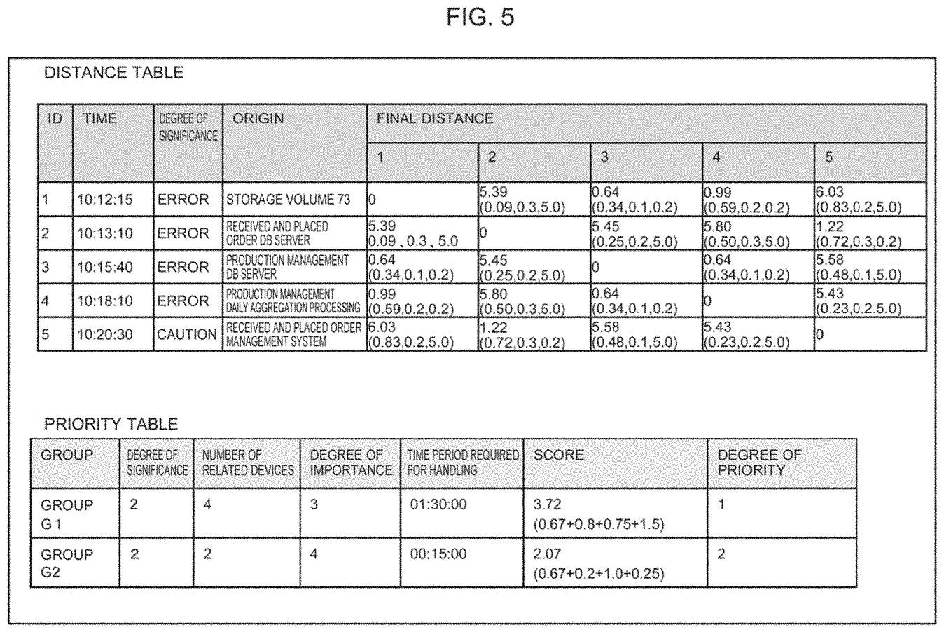

A priority table shown in FIG. 5 is data indicating a degree of significance, the number of related devices, a degree of importance, a time period required for handling, a score, and a degree of priority that are obtained with respect to each group.

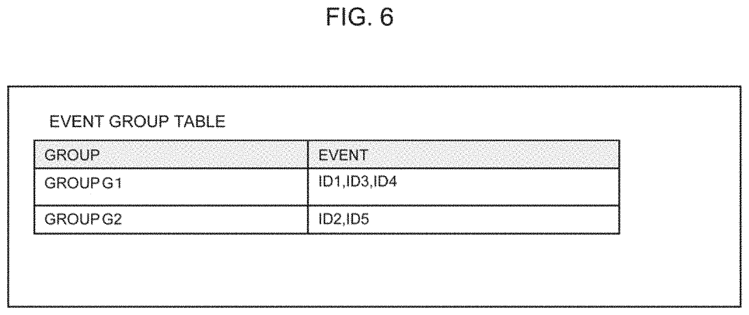

An event, group table shown in FIG. 6 is a table showing a result of grouping. In FIG. 6, the events “ID1”, “ID3”, “ID4” are classified into a group G1, and the events “ID2”, “ID5” are classified into a group G2.

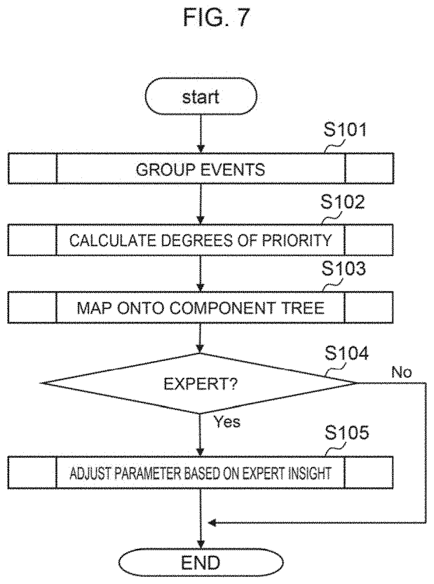

FIG. 7 is a flowchart showing a procedure of processing in the monitoring system 10. First, the event analysis section 34 of the monitoring system 10 groups events (step S101), and the degree-of-priority calculation section 33 calculates a degree of priority of each group (step S102). The notification section 32 maps each group onto a tree of the components of the monitored system 20, and causes the display section 31 to output a display (step S103).

When an operator is an expert (step S104; Yes), the event analysis section 34 acquires operation made by the expert, performs parameter adjustment based on insight of the expert (step S105), and terminates the processing. When the operator is not an expert (step S104; No), the processing is immediately terminated.

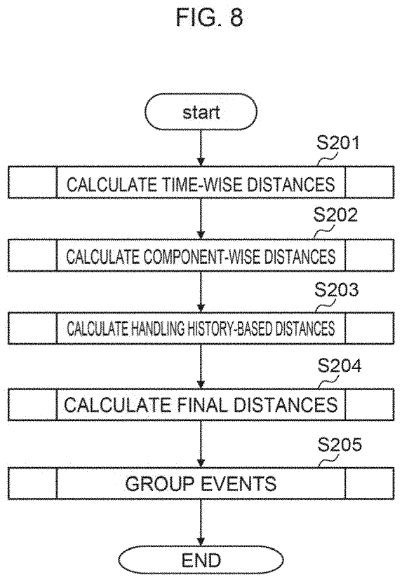

FIG. 8 is a flowchart showing details of processing for the grouping of events (S101) shown in FIG. 7. When processing for grouping events is started, the event analysis section 34 sequentially calculates time-wise distances (step S201), calculates component-wise distances (step S202), and calculates handling history-based distances (step S203), and then calculates final distances (step S204). The event analysis section 34 groups the events, based on the final distances (step S205) and returns to the original processing.

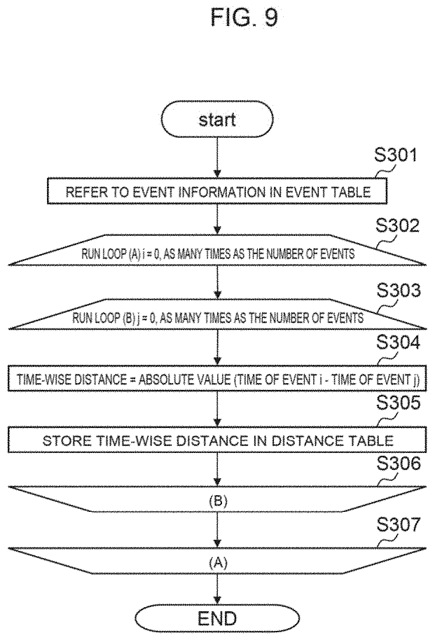

FIG. 9 is a flowchart showing details of the calculation of time-wise distances (S201) shown in FIG. When calculation of time-wise distances is started, the event analysis section 34 first refers to event information in the event table (step S301).

Steps S302 to S307 are loop processing. The event analysis section 34 repeats steps S302 to S307 by using a variable i, as many times as the number of the events.

Similarly, steps S303 to S306 are loop processing. The event analysis section 34 repeats step S303 to S306 by using a variable j, as many times as the number of the events.

In step S304, the event analysis section 34 calculates a time-wise distance between an event i and an event j, based on a following expression:

Time-wise distance=absolute value (a time of the event i−a time of the event j).

In step S305, the event analysis section 34 stores the calculated time-wise distance in the distance table.

After the loop processing in steps S302 to S307 is finished, the event analysis section 34 finishes the calculation of time-wise distances and returns to the original processing.

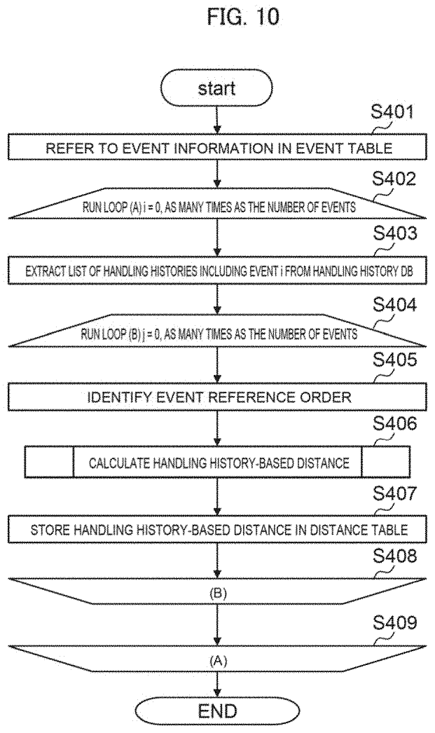

FIG. 10 is a flowchart showing details of the calculation of handling history-based distances (S203) shown in FIG. 8. When calculation of handling history-based distances is started, the event analysis section 34 first refers to the event information in the event table (step S401).

Steps S402 to S409 are loop processing. The event analysis section 34 repeats steps S402 to S409 by using a variable i, as many times as the number of the events.

In step S403, the event analysis section 34 extracts a list of handling histories including an event i from the handling history DB 43.

Steps S404 to S408 are loop processing. The event analysis section 34 repeats steps S404 to S408 by using a variable j, as many times as the number of the events.

In step S405, the event analysis section 34 identifies an event reference order. In step S406, a distance is calculated based on the event reference order Specifically, an absolute value of a difference between a place of the event i and a place of an event j in the reference order is obtained, and an average value of the absolute values is calculated as a distance. For example when the event i and the event j are referred to in two handling histories, and have first and second places in one handling history, respectively, and fifth and third places in the other handling history, respectively, then the distance is calculated as follows:

(|1−2|+|5−3|)/2=1.5.

In step S407, the event analysis section 34 stores the calculated handling history-based distance in the distance table.

After the loop processing in steps S402 to S409 is finished, the event analysis section 34 finishes the calculation of handling history-based distances and returns to the original processing.

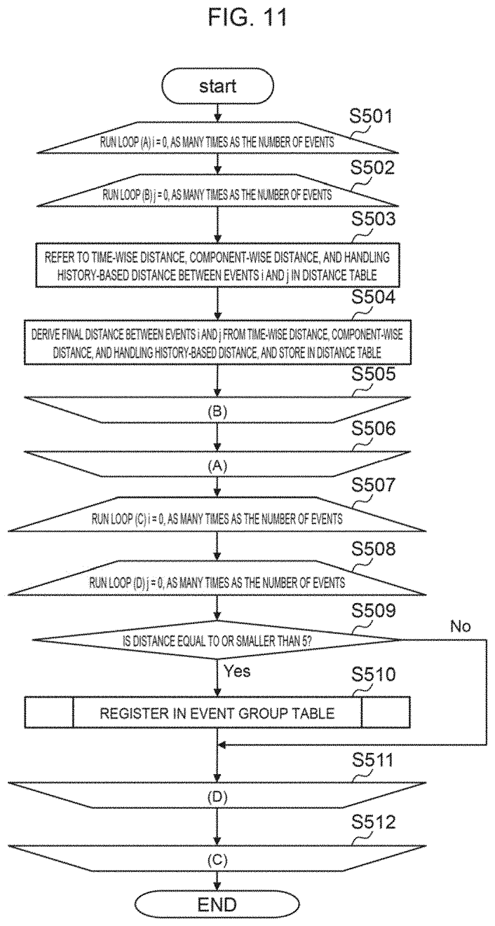

FIG. 11 is a flowchart showing details of the calculation of final distances (S204) and the grouping (S205) shown in FIG. 8. Steps S501 to S506 in FIG. 11 are details of the calculation of final distances (S204), and steps S507 to S512 in FIG. 11 are details of the grouping (S205).

Steps S501 to S506 are loop processing. The event analysis section 34 repeats steps S501 to S506 by using a variable i, as many times as the number of the events.

Similarly, steps S502 to S505 are loop processing. The event analysis section 34 repeats steps S502 to S505 by using a variable j, as many times as the number of the events.

In step S503, the event analysis section 34 refers to a time-wise distance, a component-wise distance, and a handling history-based distance between events i and j in the distance table.

In step S504, the event analysis section 34 derives a final distance between the events i and j from the time-wise distance, the component-wise distance, and the handling history-based distance, and stores the final distance in the distance table. The final distance is calculated by multiplying the time-wise distance, the component-wise distance, and the handling history-based distance by the respective coefficients indicated in the grouping parameter table, and adding up respective products.

After the loop processing in steps S501 to S506 is finished, the event analysis section 34 starts the loop processing in steps S507 to S512. The event analysis section 34 repeats steps S507 to S512 by using a variable i, as many times as the number of the events.

Similarly, steps S508 to S511 are loop processing. The event analysis section 34 repeats steps S503 to S511 by using a variable j, as many times as the number of the events.

In step S509, the event analysis section 34 determines whether or not the final distance is equal to or smaller than a threshold value (for example, 5) indicated in the grouping parameter table. As a result of the determination, the event analysis section 34 moves to step S510 when the final distance is equal to or smaller than the threshold value (step S509; Yes), and moves to step S511 when the final distance exceeds the threshold value (step S509; No).

In step S510, the event analysis section 34 registers the events i, j in the event group table, and moves to step S511.

After the loop processing in steps S507 to S512 is finished, the event analysis section 34 finishes the processing.

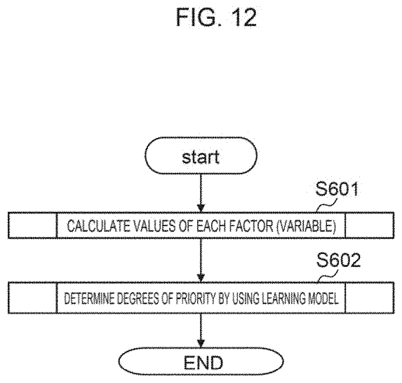

FIG. 12 is a flowchart showing details of the calculation of degrees of priority (step S102) shown in FIG. 7. When calculation of degrees of priority is started, the degree-of-priority calculation section 33 first calculates values of each factor (variable) (step S601). The factors are, specifically, a degree of significance, the number of related devices, a degree of importance, and a time period required for handling, with respect to a group.

The degree-of-priority calculation section 33 determines degrees of priority by multiplying each factor by a coefficient obtained by using a learning model, and adding up respective products (step S602), and finishes the processing. The coefficients are obtained beforehand, for example, through machine learning by using a neural network or a logistic regression model, and are stored as the priority parameter table in the analysis parameter DB 42.

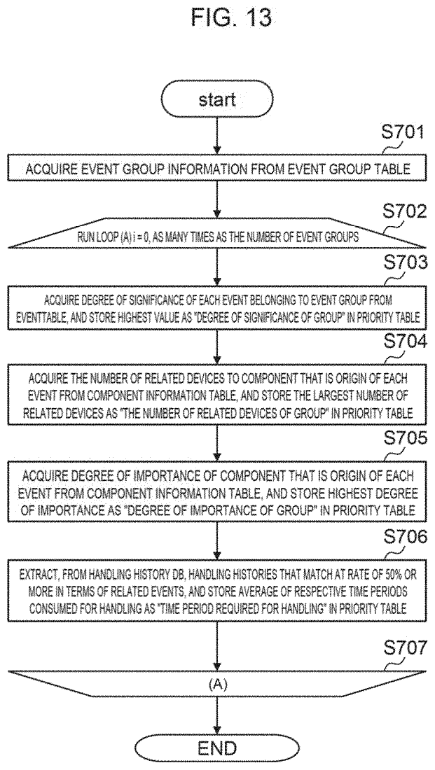

FIG. 13 is a flowchart showing details of the calculation of factor values (S601) shown in FIG. 12. The degree-of-priority calculation section 33 first acquires event group information from the event group table (step S701).

Steps S702 to S707 are loop processing. The degree-of-priority calculation section 33 repeats steps S702 to S707 by using a variable i, as many times as the number of event groups.

In step S703, the degree-of-priority calculation section 33 acquires a degree of significance of each event belonging to an event group, and stores a highest value of the degrees of significance as a “degree of significance of the group” in the priority table.

In step S704, the degree-of-priority calculation section 33 acquires the number of related devices to a component that is an origin of each event from the component information table, and stores the largest number of related devices as the “number of related devices of the group” in the priority table.

In step S705, the degree-of-priority calculation section 33 acquires a degree of importance of the component that is the origin of each event from the component information table, and stores a highest degree of importance as a “degree of importance of the group” in the priority table.

In step S706, the degree-of-priority calculation section 33 extracts, from the handling history DB 43, handling histories that match at a rate of 50% or more in terms of included related events, and stores an average of respective time periods consumed for handling as a “time period required for handling” in the priority table.

After the loop processing in steps S702 to S707 is finished, the degree-of-priority calculation section 33 finishes the processing.

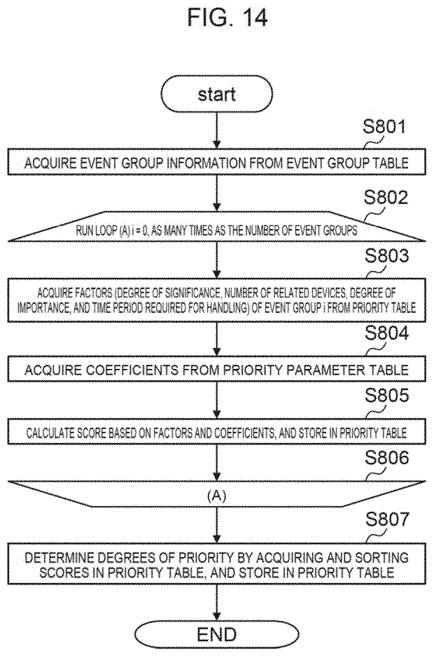

FIG. 14 is a flowchart showing details of the determination of degrees of priority (S602) shown in FIG. 12. The degree-of-priority calculation section 33 first acquires the event group information from the event group table (step S801).

Steps S802 to S806 are loop processing. The degree-of-priority calculation section 33 repeats steps S802 to S806 by using a variable i, as many times as the number of the event groups.

In step S303, the degree-of-priority calculation section 33 acquires the factors (the degree of significance, the number of related devices, the degree of importance, and the time period required for handling) of an event group i from the priority table.

In step S804, the degree-of-priority calculation section 33 acquires the coefficients from the priority parameter table.

In step S805, the degree-of-priority calculation section 33 calculates a score based on the factors and the coefficients, and stores the score in the priority table.

After the loop processing in steps S802 to S606 is finished, the degree-of-priority calculation section 33 determines degrees of priority by sorting the scores in the priority table, stores the degrees of priority in the priority table (step S607), and finishes the processing.

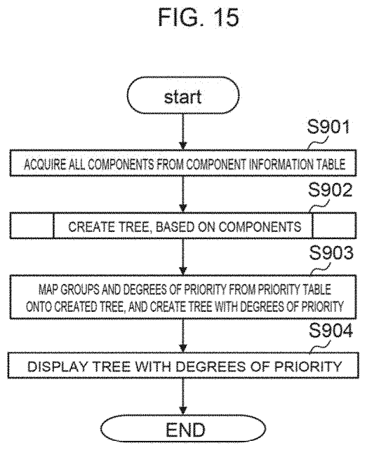

FIG. 15 is a flowchart showing details of the output of a display (step S103) shown in FIG. 7. The notification section 32 first acquires all components from the component information table (step S901). The notification section 32 creates a tree, based on relations of coupling between the acquired components (stop S902).

The notification section 32 refers to the priority table, maps the groups and the respective degrees of priority onto the created tree, and thus creates a tree with degrees of priority (step S903). Specifically, the mapping is performed by associating a group and a degree of priority with a node including ail events classified into the group. The notification section 32 causes the display section 31 to display the tree on which the groups and the respective degrees of priority are mapped (step S904), and finishes the processing.

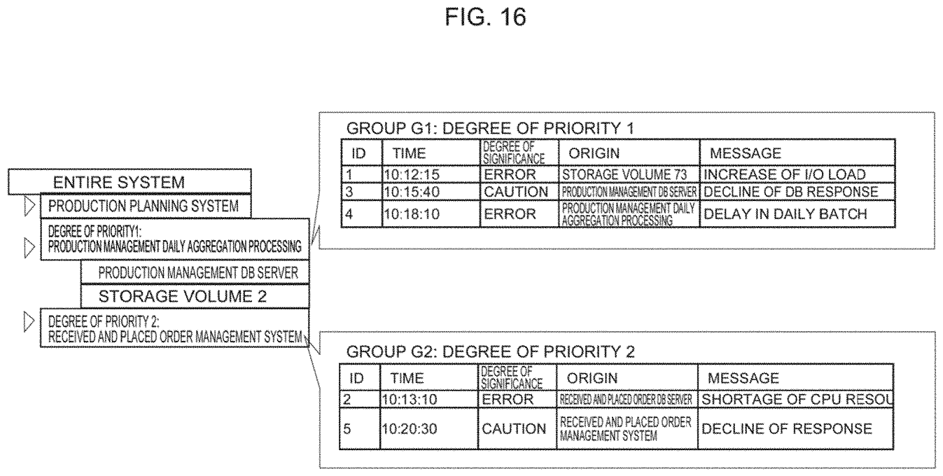

FIG. 16 is an explanatory diagram about a specific example of the display. In FIG. 16, a group G1 Is mapped to a node of “production management daily aggregation processing”. The group G1 includes the events ID1, ID3, ID4, and is given a degree of priority of “1”. Similarly a group G2 is mapped to a node of “received and placed order management system”. The group G2 includes the events ID2, ID5, and is given a degree of priority of “2”.

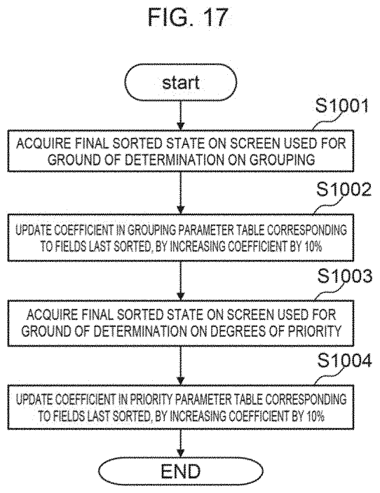

FIG. 17 is a flowchart showing details of the parameter adjustment (S105) shown in FIG. 7. The event analysis section 34 acquires a final sorted state on a screen that the expert uses for a ground of determination on grouping (step S1001). The event analysis section 34 updates the grouping parameter table by increasing, by 10%, a coefficient for a grouping parameter corresponding to fields last sorted by the expert (step S1002).

Similarly, the degree-of-priority calculation section 33 acquires a final sorted state on a screen that the expert uses for a ground of determination on degrees of priority (step S1003). The degree-of-priority calculation section 33 updates the priority parameter table by increasing, by 10%, a coefficient for a priority parameter corresponding to fields last sorted by the expert (step S1004).

After the monitoring system 10 outputs results of the determination on the grouping and the degrees of priority, if the expert performs sorting based on a parameter other than the final distance or the score, it can be presumed that the expert makes a determination that is different from the results of the determination by the monitoring system 10. In such a case, it can be thought that the parameter based on which the expert performs sorting is used for a ground of the determination made by the expert. Accordingly, a determination made by the monitoring system 10 thereafter can be expected to become closer to the determination made by the expert, by increasing a weight, of the parameter based on which the expert performs sorting. Note that if the expert performs sorting based on the final distance or the score, the parameters need not be updated because it can be presumed that the expert checks details of the determination made by the monitoring system 10 and deems the results of the determination adequate.

As described above, the monitoring system 10 according to the present embodiment includes: the event management section 37 that manages a plurality of events occurring in the monitored system 20; the event analysis section 34 that analyzes the plurality of events, based on the components of the monitored system 20, timings of occurrence of the plurality of events, and records of handling performed in the past, and classifies relatedly occurring events into the same group; and a notification section 32 that notifies the plurality of events on a group basis. With such a configuration and operation, it is made possible to grasp a situation and to more quickly provide handling when a failure occurs in the monitored system 20. For example, even when a plurality of failures simultaneously occur, the failures can be quickly handled.

The monitoring system 10 according to the present embodiment further includes the degree-of-priority calculation section 33 that calculates a degree of priority of a group, with respect to each group, based on a degree of significance, the number of related devices, a degree of importance of a system, and a time period required for handling of each event classified into the group. In the monitoring system 10 according to the present embodiment, the notification section 32 displays the components of the monitored system in a form of a tree structure, and displays each group in such a manner that the group is associated with an uppermost node, in the tree, that includes events classified into the group. Accordingly, an operator can appropriately determine which event should be handled first.

In the monitoring system 10 according to the present embodiment, the event analysis section 34 adjusts a parameter involved in group classification, based on operation made by an operator who satisfies a predetermined condition. Accordingly, accuracy in determination made by the monitoring system 10 can be gradually enhanced.

In the monitoring system 10 according to the present embodiment, the monitored system 20 includes a plurality of service systems that provide a plurality of services, respectively, and the event analysis section 34 can classify a plurality of events occurring across different service systems into the same group. Accordingly, even if the monitored system has a large-scale complicated configuration, it is made possible to grasp a situation and to more quickly provide handling when a failure occurs.

Note that the present invention is not limited to the above-described embodiment, and incorporates various modifications. For example, the above-described embodiment has been described minutely to facilitate understanding of the present invention, and the present invention is not necessarily limited to systems and the like that include ail of the described components. Not limited to omission of any of the components, replacement and addition of a component can also be made.

For example, although a detailed description of the calculation of distances based on the components of the monitored system is omitted in the above-described embodiment, the component-wise distances can be calculated by using an arbitrary method, such as obtaining the number of hops between components as a distance.

Moreover, although evaluation based on details of an event is performed by obtaining a distance based on past records of handling in the above-described embodiment, a distance between event types may be defined beforehand.

The monitored system disclosed in the above-described embodiment is only an example, and the embodiment can be worked by using any system for a monitored system.

### REFERENCE SIGNS LIST

10: monitoring system, 20: monitored system, 31: display section, 32: notification section, 33: degree-of-priority calculation section, 34: event analysis section, 35: handling history management section, 36: component management section, 37: event management section, 41: component information OB, 42: analysis parameter DB, 43: handling history DB, 44: human resource management DB, 45: event DB

What is claimed is:

1. A monitoring system comprising:
an event management section that manages a plurality of events occurring in a monitored system;
an event analysis section that analyzes the plurality of events, based on components of the monitored system, timings of occurrence of the plurality of events, and records of handling performed in a past, and classifies relatedly occurring events into a same group; and
a notification section that notifies the plurality of events on a basis of the group.

2. The monitoring system according to claim 1, further comprising a degree-of-priority calculation section that calculates a degree of priority of the group, with respect to each group, based on a degree of significance, the number of related devices, a degree of importance of a system, and a time period required for handling of each event classified into the group,
wherein the notification section notifies the degree of priority along with the group.

3. The monitoring system according to claim 1, wherein the notification section displays the components of the monitored system in a form of a tree structure, and displays the group in such a manner that the group is associated with an uppermost node, in a tree, that includes the events classified into the group.

4. The monitoring system according to claim 1, wherein the event analysis section adjusts a parameter involved in the classification into the group, based on operation made by an operator who satisfies a predetermined condition.

5. The monitoring system according to claim 1, wherein the monitored system includes a plurality of service systems that provide a plurality of services, respectively, and
the event analysis section can classify a plurality of events occurring across different service systems into a same group.

6. A monitoring apparatus comprising:
an event management section that manages a plurality of events occurring in a monitored system;
an event, analysis section that analyzes the plurality of events, based on components of the monitored system, timings of occurrence of the plurality of events, and records of handling performed in a past, and classifies relatedly occurring events into a same group; and
a notification section that notifies the plurality of events on a basis of the group.

7. A monitoring method comprising:
an event management step of managing a plurality of events occurring in a monitored system;
an event analysis step of analyzing the plurality of events, based on components of the monitored system, timings of occurrence of the plurality of events, and records of handling performed in a past, and classifying relatedly occurring events into a same group; and
a notification step of notifying the plurality of events on a basis of the group.
